(19) United States
(12) Patent Application Publication
(10) Pub. No.: US 2010/0170366 A1
(43) Pub. Date: Jul. 8, 2010

(54) SURVEY HUB INSTALLATION APPARATUS AND METHOD OF USE

(76) Inventor: CLYDE GOEKE, Benton City, WA (US)

Correspondence Address: FLOYD E. IVEY;IVEY Law Offices, P.S. Corp., 7233 W. Deschutes Ave., Suite C, BOX #3, KENNEWICK, WA, 99336, US

(21) Appl. No.: 12/348,246

(22) Filed: Jan. 2, 2009

(51) Int. Cl. B25D 1/16

(52) U.S. Cl. 81/27; 173/128; 29/254

(57) ABSTRACT

The Survey Hub Installation apparatus is principally comprises an elongated rod having a penetration point and penetration anvil at a first end and a Hub receptacle and Hub receptacle anvil at a second end. A hammer is tubularly received at the rod intermediate the penetration anvil and the Hub receptacle anvil. A feather receptacle and a feather hammer is formed at the second end.

### FIELD OF THE INVENTION

This invention relates to an apparatus which installs survey Hubs and feathers at the top of a survey Hub and the method of use of the apparatus.

### BACKGROUND OF THE INVENTION

Surveyors install or place Hubs in accordance with engineering drawings. Frequently, the installation will be in or through a hard or rocky surface including asphalt. Use of hammers, including sledge hammers, are problematic regarding the penetration of such surfaces by striking a Hub. The top of the Hub may also be required to be placed below the surface of the ground or other surface where the Hub is to be positioned. The use of sledge hammer, in such a condition, can result in the formation of a large hole in the ground or surface. This invention provides a tool for both installation of a Hub and a Feather at the top of the Hub in either hard surface conditions or where the Hub top will be beneath the surface.

The patents referred to herein are provided herewith in an Information Disclosure Statement in accordance with 37 CFR 1.97.

### SUMMARY OF THE INVENTION

The Apparatus (1) disclosed herein is for placement of a Hub is comprised of a rod (100) having a penetration anvil (200) and a penetration point (220) at a first end (120) and a hub receptacle (300) and a hub receptacle anvil (320) at a second end (140). A hammer (400) is formed intermediate the first end (120) and the second end (140) which may exert force against either the penetration anvil (200) or the hub receptacle anvil (320). A feather receptacle (400) is formed proximal the hub receptacle (300). A feather hammer (420) is received by the feather receptacle (400) for the placement of a feather at the Hub top.

### BRIEF DESCRIPTION OF THE DRAWINGS

The foregoing and other features and advantages of the present invention will become more readily appreciated as the same become better understood by reference to the following detailed description of the preferred embodiment of the invention when taken in conjunction with the accompanying drawings, wherein:

FIG. 1 illustrates a Survey Hub Installation Apparatus (1). Shown is an elongated rod (100) having a first end (120), a second end (140), a rod axis (160), a penetration point (200), a penetration anvil (220), penetration anvil affixing means (240), a hub receptacle (300), a hub receptacle wall (310), a hub receptacle anvil (320), hub receptacle anvil affixing means (340), a hammer (400), a hammer first end (420), a hammer second end (440), a hammer aperture (460), a feather receptacle (500), a feather receptacle aperture (510), a feather hammer (520), a feather hammer guide (540) and a feather hammer retainer affixing means (544).

FIG. 2 illustrates a survey hub (600) having a hub point (620) and a survey hub top (630).

FIG. 3 illustrates an alternative embodiment of a hammer showing at least two hammers (400) affixed to and separated by a hammer sleeve (480).

FIG. 4 illustrates the Survey Hub Installation Apparatus (1) at the second end (140). Seen is a hub receptacle (300), a hub receptacle wall (310), a hub receptacle anvil (320), hub receptacle anvil affixing means (340), a feather receptacle (500), a feather receptacle aperture (510), a feather hammer assembly (580), a feather hammer (520), a feather hammer guide (540) and a feather hammer retainer affixing means (544).

FIG. 4A shows section 4A from FIG. 4 illustrating an elongated rod (100), an elongated rod diameter D2 (110), a hub receptacle wall (310), a feather receptacle (500), a feather receptacle aperture (510) and a feather hammer (520).

FIG. 5 illustrates detail 5 from FIG. 4 showing a hub receptacle (300), a hub receptacle wall (310), a hub receptacle wall dimension (315), a feather receptacle (500), a feather receptacle aperture (510), a feather receptacle aperture diameter D3 (515), a feather hammer (520), a feather hammer diameter D5 (530), a feather sleeve (550), a feather strand (555), a feather strand guide (560), a feather sleeve (560), a feather sleeve diameter D4 (565), a feather sleeve length L1 (567), a feather pin (570) and feather hammer assembly (580).

FIG. 5A shows detail 5A from FIG. 5. Illustrated is a feather receptacle aperture diameter D3 (515), a feather hammer (520), a feather hammer diameter D5 (530), a feather sleeve (560) and a feather sleeve diameter D4 (565).

FIG. 6 illustrates and alternative embodiment of a feather hammer assembly (580) showing a feather receptacle (500), a feather receptacle aperture (510), a feather hammer (520), a feather hammer guide (540), a feather hammer guide slot (541), a feather hammer feather slot (543), a feather sleeve (550), a feather strand (555), feather strand guide (560), a feather pin (570), at least one feather hammer retainer (525).

FIG. 7 illustrates a Survey Hub Installation Apparatus (1) showing the elongated rod (100), a hub receptacle (300), a hub receptacle wall (310), a feather hammer assembly (580), a feather receptacle (500), a feather hammer assembly slot (502), a feather receptacle aperture (510), a feather hammer (520), a feather hammer retainer (525), a feather hammer guide (540), a feather hammer guide slot (541), a feather hammer feather slot (543), a feather hammer guide affixing means (544) and a feather hammer guide retainer clip (545).

### DETAILED DESCRIPTION

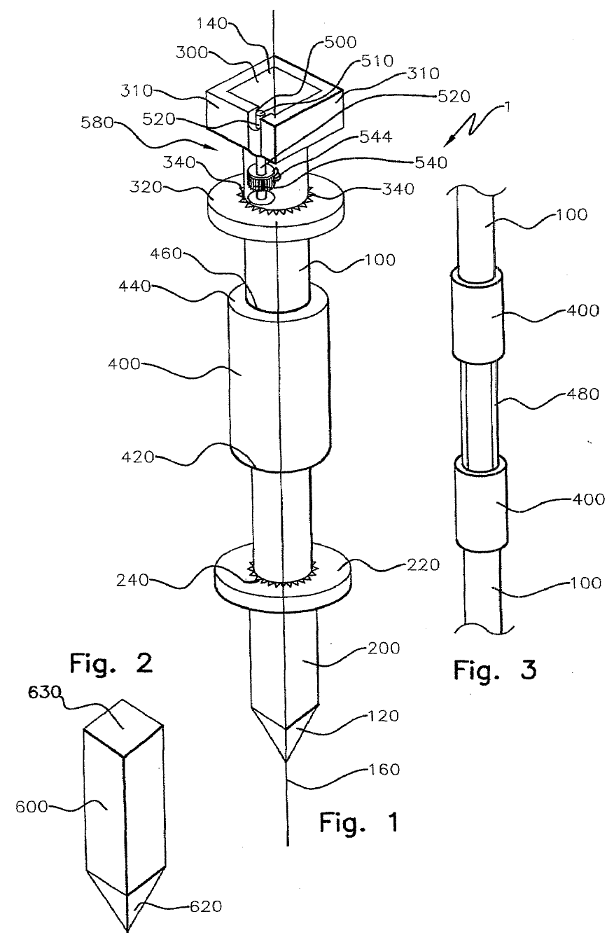

FIG. 1 illustrates A Survey Hub Installation Apparatus (1) showing an elongated rod (100) being generally cylindrical and formed of a rigid material including metals and having an elongated rod diameter D2 (110). The rod (100) has a first end (120) and a second end (140) and a rod axis (160) from the first and (120) to the second end (140). The rod (100) has a penetration point (200) at the first end (120) and a penetration anvil (220), formed of rigid materials including metals, proximal the first end (120). The penetration point (200) will be pointed and formed of materials, including metals, capable of penetration of hard soils, asphalt and other surfaces encountered in survey work. The penetration anvil (220) is affixed to the rod (100) by penetration anvil affixing means (240) including welding and metal forming and is generally disk shaped.

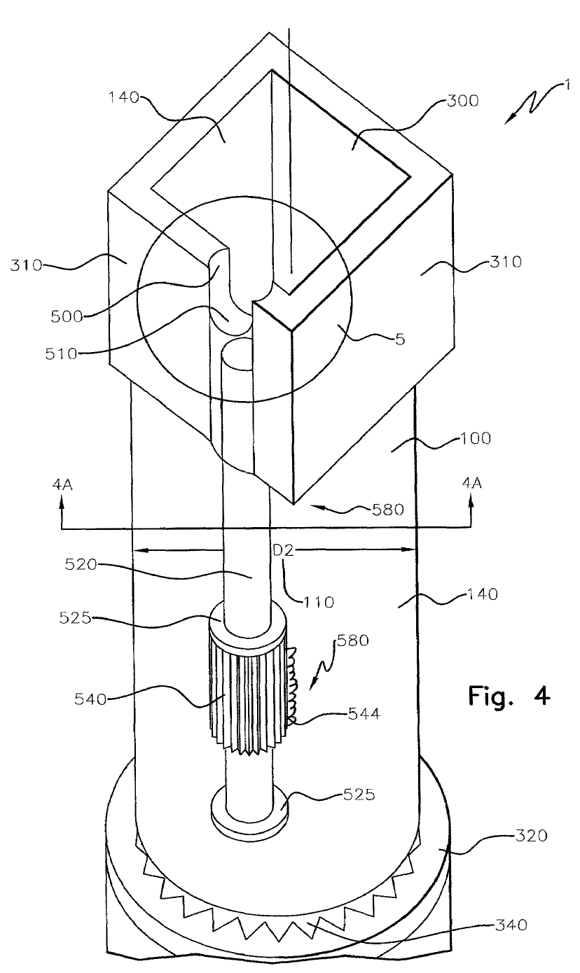

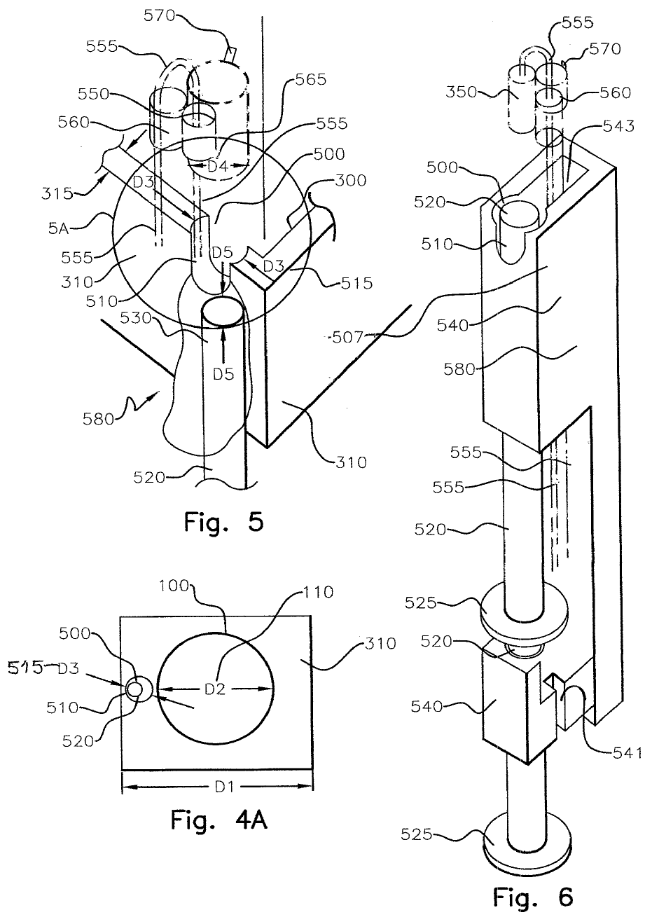

Seen in FIGS. 1, 4, and 7, the rod (100) at the second end (140) has a hub receptacle (300) which is generally rectangular or square, but may be circular, and having a hub receptacle wall (310) which has a hub receptacle wall dimension (315). The hub receptacle (300) is recessed and sized and shaped to receive a survey hub (600) at a survey hub top (630). A hub receptacle anvil (320), illustrated in FIGS. 1 and 4, is affixed to the rod (100), proximal the hub receptacle (300), by hub receptacle anvil affixing means (340) including welding and metal forming. The hub receptacle anvil (320) is generally disk shaped and formed of rigid material including metals.

A least one generally cylindrical hammer (400), shown in FIGS. 1 and 2, is generally formed of a rigid material including metals, has a hammer first end (420), a hammer second end (440) and a hammer aperture (460). The hammer aperture is sized and shaped to slidably receive the rod (100). The at least one hammer (400) is positioned intermediate the penetration anvil (220) and the hub receptacle anvil (320). The penetration anvil (220) and the hub receptacle anvil (320) are flat facing the at least one hammer (400). The at least one hammer (400), in the preferred embodiment, is comprised of at least two hammers (400) connected by a generally cylindrical hammer sleeve (480). The hammer sleeve (480) is sized and shaped to be slidably received by the rod (100) and to be seized by a survey operator.

A feather hammer assembly (580), illustrated in FIGS. 1, 4, 4A, 5, 5A, 6 and 7, is formed integrally into the hub receptacle wall (310) and affixed to the rod (100) or is formed to be removably received into a feather hammer assembly slot (502) and removably affixed to the rod (100). The feather hammer assembly (580) includes a feather receptacle (500) formed in the hub receptacle wall (310) or positioned in the hub receptacle wall (310) as a part of a removable feather hammer assembly (580). The feather receptacle (500) is an aperture in the hub receptacle wall (310) or in the removable feather hammer assembly (580) which is parallel to the rod axis (160). A feather receptacle aperture (510) is “U” shaped at and facing the second end (140) to allow a feather sleeve (560) to be received into the feather receptacle (500) so as to position a feather sleeve (560) at or somewhat distal to the extremity of the second end (140) thus preventing unwanted contact between the a feather pin (570) and the survey hub top (630) prior to the operation of positioning a feather (550) at the survey hub top (630). A feather sleeve (560) has a feather sleeve diameter D4 (565) which is sized to be loosely friction retained in the feather receptacle (500) which has a lesser diameter than a feather receptacle aperture diameter D3 (515).

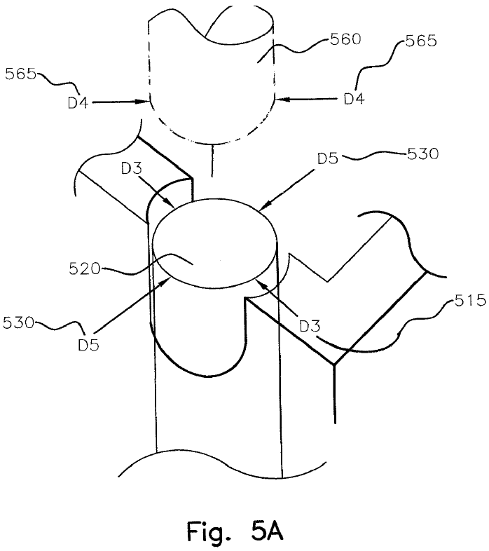

A generally elongated and cylindrical feather hammer (520), seen in FIGS. 1, 5, 5A, 6 and 7, composed of a rigid material including metals, has a feather hammer diameter D5 (530) which is less than the diameter of the feather receptacle aperture diameter D3 (515) thereby allowing the feather hammer (520) to be slidably received while being approximately the diameter of a feather sleeve diameter D4 (565) to impart force against the feather sleeve (560) thereby urging an outwardly extending tab shaped feather pin (570) to penetrate a survey hub top (630) and hence positioning an upstanding feather strand (555), generally composed of brightly colored plastic fibers, for construction viewing of a survey hub (600). The feather pin (570), illustrated in FIGS. 5 and 6, expected in the generally available feather sleeves (560) is an upstanding metal tab which penetrates the survey hub top (630) and positions the feather (550) to be seen by construction workers. It is recognized that the feather (550) and survey hub (600) are not inventions disclosed or claimed herein. However, the claim recitation regarding the feather pin (570) and survey hub (600) are meant to illustrate that a feather pin (570) may be composed of a metal tab or another mechanism, such as an adhesive, that would affix a feather (550) to the survey hub top (630). The survey hub (600) commonly seen in survey work is a wooden stake, illustrated in FIG. 2. It will be known to those of ordinary skills that survey hubs (600) may be composed of other materials.

The feather hammer (520) is retained and guided by a feather hammer guide (540), illustrated in FIGS. 4, 6 and 7, which receives the feather hammer (520) by an aperture parallel to the rod axis (160). The feather hammer guide (540) is affixed to the rod (100) by feather hammer retainer affixing means (544) including welding and metal forming.

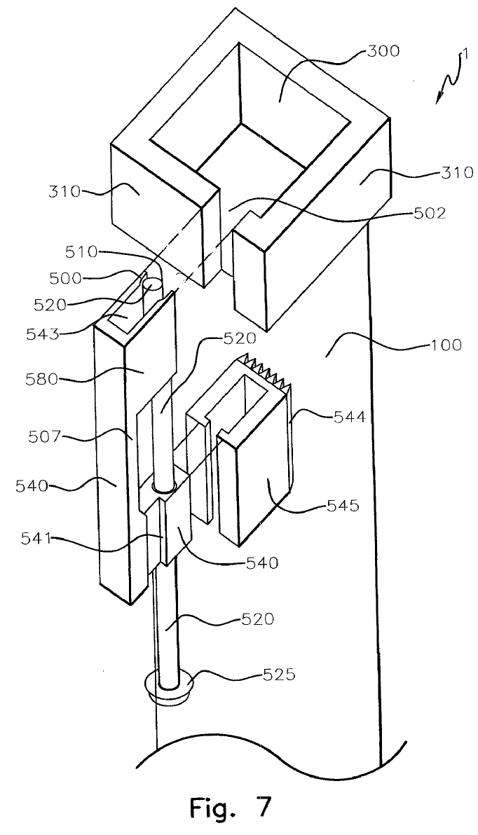

When the feather hammer assembly (580) is removable, as seen in FIGS. 6 and 7, there is a feather hammer guide slot (541), on each side of the feather hammer assembly (580) which is parallel to the rod axis (160), intermediate the feather hammer guide (540) and the rod (100) and aligned with a feather hammer retainer clip (545). The feather hammer retainer clip (545), shown in FIG. 7, is affixed by retainer clip retainer means including welding and metal forming to the rod (100). The feather hammer retainer clip (545) provides a spring clip function by outwardly extending arms, having a spring function, which terminate in arm tips formed and shaped to be snap received into the feather hammer guide slots (541).

A feather hammer feather slot (543), illustrated in FIGS. 6 and 7, is an aperture parallel to the feather hammer (520) extending downwardly from the outermost portion of the hub receptacle wall (310) to a position proximal the feather hammer guide (540). The feather hammer feather slot (543) receives a feather (550) composed of multiple brightly colored plastic feather strands (555) secured in at least one cylindrical sleeve, affixed to the feather sleeve (560), and guided downwardly through the feather hammer feather slot (543).

I claim:

1. A Survey Hub Installation Apparatus (1) comprising:
a. an elongated rod (100) having a first end (120) and a second end (140);
b. a penetration point (200) at the first end (120) and a penetration anvil (220) proximal the first end (120); a hub receptacle (300) at the second end (140) and a hub receptacle anvil (320) proximal the second end (140); the hub receptacle (300) having at least one hub receptacle wall (310);
c. a hammer (400) intermediate the penetration anvil (22) and the hub receptacle anvil (300);
d. a feather receptacle (500) permanently formed into the at least one hub receptacle wall (310) or removably affixed at the at least one hub receptacle wall (310), by feather receptacle (500) affixing means including a feather hammer retainer clip (545) affixed by rod affixing means of welding or metal forming;
e. a generally elongated cylindrical feather hammer (520), formed generally of a rigid material including metals, is aligned with the feather receptacle (500) and is slidably received by and affixed by feather hammer (520) affixing means, including welding and metal forming, to the elongated rod (100) intermediate the hub receptacle (300) and the hub receptacle anvil (320);
e. the penetration point (200) is elongated and shaped as a hub point (620); the hub receptacle (300), most distal to the penetration point (200) is shaped to receive a survey hub at a survey hub top (630);
f. the rod (100) has a rod axis (160) centered from the first end (120) to the second end (140); the penetration anvil (220), proximal the penetration point (200), is disk shaped, is planar distal to the penetration point (200) with the planar surface orthogonal to the rod axis (160); the hub receptacle anvil (320), proximal the hub receptacle (300) is disk shaped, is planar distal to the hub receptacle (300) with the planar surface orthogonal to the rod axis (160);
g. the hammer (400) is generally cylindrical, has a hammer first end (420) and a hammer second end (440) and a hammer aperture (460) centrally positioned from the hammer first end (420) to the hammer second end (440); the hammer aperture (460) is sized to movably receive the rod (100) intermediate the penetration anvil (220) and the hub receptacle anvil (320); the hammer first end (420) is planar and is orthogonal to the rod axis (160); the hammer second end (440) is planar and is orthogonal to the rod axis (160); the hammer first end (420) strikes the penetration anvil (220) to drive the penetration point (200) into a surface;
h. the hub receptacle (300) is sized and shaped to receive a survey hub top (630); the hammer second end (440) strikes the hub receptacle anvil (320) forcing the hub receptacle (300) against the survey hub top (630) driving the survey hub (600) into a shaft formed by the penetration point (200);
I. the rod (100), the penetration point (200), the penetration point anvil (220), the hub receptacle (300), the hub receptacle anvil (320) and the hammer (400) formed generally of rigid materials including metals; the penetration point (200), the penetration point anvil (220), the hub receptacle (300) and the hub receptacle anvil (320) affixed to the rod (100) by rod affixing means (340) including welding, threads, and material forming;
j. the rod (100) is generally cylindrical and has a rod diameter D2 (110); the feather receptacle (500) is generally cylindrical having a feather receptacle aperture (510); the feather receptacle aperture (510) has a feather receptacle aperture diameter D3 (515); the feather hammer (520) is generally cylindrical having a feather hammer diameter D5 (530) which is less than the feather receptacle aperture diameter D3 (515) and which is slidably received by the feather receptacle aperture diameter D3 (515);
k. the feather (550) has a feather sleeve (560); the feather sleeve (560) is generally cylindrical and has a feather sleeve diameter D4 (565); the feather sleeve diameter D4 (565) is less than the feather receptacle aperture diameter D3 (515); the feather (550) is slidably received by the feather receptacle aperture (500) and is secured in the feather receptacle aperture (500) by friction; the feather sleeve diameter D4 (565) is less than the feather hammer diameter D5 (530); the feather hammer (520) is in general alignment with the rod axis (160) and is retained in said alignment by a feather hammer guide (540) which is generally cylindrical and which slidably receives the feather hammer (520); at least one feather hammer collar (525) immovably affixed, by feather hammer collar affixing means, to the feather hammer (520).

2. A Survey Hub Installation Apparatus (1) comprising:
a. an elongated rod (100) having a first end (120) and a second end (140);
b. a penetration point (200) at the first end (120) and a penetration anvil (220) proximal the first end (120); a hub receptacle (300) at the second end (140) and a hub receptacle anvil (320) proximal the second end (140);
c. a slidable hammer (400) intermediate the penetration anvil (22) and the hub receptacle anvil (320);
d. a feather receptacle (500) proximal the hub receptacle (300) and a feather hammer (520) aligned with the feather receptacle (500) and aligned with and parallel to the rod axis (160); the feather receptacle (500) immovably or removably affixed proximal or to the hub receptacle (300); and the feather hammer (520) and rod (100).

3. The apparatus of claim 2 further comprising:
a. the penetration point (200) is elongated having a point at the first end (120); the hub receptacle (300), most distal to the penetration point (200) is sized and shaped to receive a survey hub top (630); the survey hub top (630) is generally formed as a recessed rectangle or a recessed cylindrical depression;
b. the rod (100) has a rod axis (160) centered from the first end (120) to the second end (140); the penetration anvil (220), proximal the penetration point (200), is planar with the planar surface orthogonal to the rod axis (160); the hub receptacle anvil (320), proximal the hub receptacle (300) is planar with the planar surface orthogonal to the rod axis (160);
c. the hub receptacle (300) having at least one hub receptacle wall (310); a feather receptacle (500) is affixed proximal the hub receptacle (300) or formed in the at least one hub receptacle wall (310) and a feather hammer (520) is aligned with the feather receptacle (500) and parallel to the rod axis (160); the feather receptacle (500) is immovably or removably affixed to the hub receptacle (300); the feather hammer (520) immovably or removably affixed to the hub receptacle (300) or the rod (100);
d. the hammer (400) is generally cylindrical, has a hammer first end (420) and a hammer second end (440) and a hammer aperture (460) centrally positioned from the hammer first end (420) to the hammer second end (440); the hammer aperture (460) is sized to slidably and movably receive the rod (100) intermediate the penetration anvil (220) and the hub receptacle anvil (320); the hammer first end (420) is planar and is orthogonal to the rod axis (160); the hammer second end (440) is planar and is orthogonal to the rod axis (160);
e. the penetration point (200), the penetration point anvil (220), the hub receptacle (300) and the hub receptacle anvil (320) are affixed to the rod (100) by rod affixing means (340); said rod affixing means (340) immovably affixes the penetration point anvil (220) and the hub receptacle anvil (320) to the rod (100) and includes welding.

4. The apparatus of claim 3 further comprising:
a. the penetration point (200) is shaped as a survey hub (600) having a hub point (620); the penetration anvil (220), proximal the penetration point (200), is disk shaped, the hub receptacle anvil (320), proximal the hub receptacle (300) is disk shaped,
b. the hammer first end (420) strikes the penetration anvil (220) to drive the penetration point (200) into a surface; the hammer second end (440) strikes the hub receptacle anvil (320) driving a survey hub (600) into a shaft formed by the penetration point (200);
c. the feather receptacle (500) proximal the hub receptacle (300) or in the at least one hub receptacle wall (310) and the feather hammer (520) aligned with the feather receptacle (500) and aligned with and parallel to the rod axis (160); the feather receptacle (500) and the feather hammer (520) immovably or removably affixed to the hub receptacle (300) and rod (100).

5. A Survey Hub Installation Apparatus (1) comprising:
a. an elongated rod (100) being generally cylindrical and formed of a rigid material including metals and having an elongated rod diameter D2 (110); the rod (100) has a first end (120) and a second end (140) and a rod axis (160) from the first and (120) to the second end (140); the rod (100) has a penetration point (200) at the first end (120) and a penetration anvil (220), formed of rigid materials including metals, proximal the first end (120); the penetration anvil (220) is affixed to the rod (100) by penetration anvil affixing means (240) including welding and metal forming; the penetration anvil (220) is generally disk shaped;
b. the rod (100) at the second end (140) has a hub receptacle (300) which is generally rectangular or square, but may be circular, and having a hub receptacle wall (310) which has a hub receptacle wall dimension (315); the hub receptacle (300) is recessed and sized and shaped to receive a survey hub (600) at a survey hub top (630);
c. a hub receptacle anvil (320) is affixed to the rod (100), proximal the hub receptacle (300), by hub receptacle anvil affixing means (340) including welding and metal forming; the hub receptacle anvil (320) is generally disk shaped and formed of rigid material including metals;
d. at least one generally cylindrical hammer (400), generally formed of a rigid material including metals, has a hammer first end (420), a hammer second end (440) and a hammer aperture (460); the hammer aperture is sized and shaped to receive the rod (100); the at least one hammer (400) is positioned intermediate the penetration anvil (220) and the hub receptacle anvil (320); the penetration anvil (220) and the hub receptacle anvil (320) are flat facing the at least one hammer (400); the at least one hammer (400) comprised of at least two hammers (400) connected by a generally cylindrical hammer sleeve (480); the hammer sleeve (480) is sized and shaped to be slidably received by the rod (100);
e. a feather hammer assembly (580) is formed integrally into the hub receptacle wall (310) and affixed to the rod (100) or is formed to be removably received into a feather hammer assembly slot (502) and removably affixed to the rod (100); the feather hammer assembly (580) includes a feather receptacle (500) formed in the hub receptacle wall (310) as a part of a removable feather hammer assembly (580); the feather receptacle (500) is an aperture in the hub receptacle wall (310) or in the removable feather hammer assembly (580) which is parallel to the rod axis (160); a feather receptacle aperture (510) is “U” shaped at and facing the second end (140) to allow a feather sleeve (560) to be received into the feather receptacle (500); a feather sleeve (560) has a feather sleeve diameter D4 (565) which is sized to be friction retained in the feather receptacle (500) which has a lesser diameter than a feather receptacle aperture diameter D3 (515);
f. a generally elongated and cylindrical feather hammer (520), composed of a rigid material including metals, has a feather hammer diameter D5 (530) which is less than the diameter of the feather receptacle aperture diameter D3 (515) thereby allowing the feather hammer (520) to be slidably received while being approximately the diameter of a feather sleeve diameter D4 (565) to impart force against the feather sleeve (560) thereby urging an outwardly extending tab shaped feather pin (570) to penetrate a survey hub top (630) and hence positioning an upstanding feather strand (555), generally composed of brightly colored plastic fibers, for construction viewing of a survey hub (600);
g. the feather hammer (520) is retained and guided by a feather hammer guide (540) which receives the feather hammer (520) by an aperture parallel to the rod axis (160); the feather hammer guide (540) is affixed to the rod (100) by feather hammer retainer affixing means (544) including welding and metal forming;
h. when the feather hammer assembly (580) is removable a feather hammer body (507), generally rectangular in cross-section and composed of a rigid material including metals, is sized to be received into a feather hammer assembly slot (502) formed integrally into the hub receptacle wall (310); there is a feather hammer guide slot (541), on each side of the feather hammer assembly (580) which is parallel to the rod axis (160), intermediate the feather hammer guide (540) and the rod (100) and aligned with a feather hammer retainer clip (545); the feather hammer retainer clip (545) is affixed by retainer clip retainer means including welding and metal forming to the rod (100); the feather hammer retainer clip (545) provides a spring clip function by outwardly extending arms, having a spring function, which terminate in arm tips formed and shaped to be snap received into the feather hammer guide slots (541);
I. a feather hammer feather slot (543) is an aperture parallel to the feather hammer (520) extending downwardly from the outermost portion of the hub receptacle wall (310) to a position proximal the feather hammer guide (540); the feather hammer feather slot (543) receives a feather (550) composed of multiple brightly colored plastic feather strands (555) secured in at least one cylindrical sleeve, affixed to the feather sleeve (560) and guided downwardly through the feather hammer feather slot (543).

6. The Method of Use of A Survey Hub Installation Apparatus (1) of claim 5 comprising:
a. placing the first end (120) at the location of placement of a survey hub (600); an operator grasping the at least one hammer (400) or the hammer sleeve (480) and impacting the penetration anvil (220) with the at least on hammer (400) by slidably moving the at least one hammer (400) up and down to force the first end (120) to create a penetration which will receive a survey hub (600) at a hub point (620);
b. placing the survey hub (600) into the penetration made by the penetration anvil (220); positioning the Survey Hub Installation Apparatus (1) second end (140) and hub receptacle (300) to receive the survey hub top (630) into the recessed hub receptacle (300); the operator grasping the at least one hammer (400) or the hammer sleeve (480) and impacting the hub receptacle anvil (320) with the at least on hammer (400) by slidably moving the at least one hammer (400) up and down to force the survey hub (600) into the penetration to a depth dictated by survey data;
c. placing a feather (550) into the feather receptacle aperture (510); positioning the first end (120) proximal the survey hub top (630); striking the feather hammer (520) causing the feather (550) to impact the survey hub top (630) and causing the feather pin (570) to fixedly contact the survey hub top (630).
